(19) United States
(12) Patent Application Publication
(10) Pub. No.: US 2026/0052045 A1
(43) Pub. Date: Feb. 19, 2026

(54) MONITOR CIRCUITRY FOR DECISION FEEDBACK EQUALIZED RECEIVER

(71) Applicant: Rambus Inc., San Jose, CA (US)

(72) Inventors: Kumail Khozema KHURRAM, Bangalore (IN); Divanshu CHATURVEDI, Bengaluru (IN); Kapil VYAS, Bengaluru (IN); Muralidhar CHINNAM, Bengaluru (IN)

(21) Appl. No.: 19/284,461

(22) Filed: Jul. 29, 2025

Related U.S. Application Data
(60) Provisional application No. 63/682,626, filed on Aug. 13, 2024.

(51) Int. Cl. H04L 25/03; H04B 1/12

(52) U.S. Cl. CPC H04L 25/03267; H04B 1/12; H04L 2025/03471

(57) ABSTRACT

Decision feedback equalization (DFE) is used to help reduce inter-symbol interference (ISI). Additional equalization may also be applied to an input signal using analog front-end (AFE) circuitry with, for example, a continuous-time linear equalizer (CTLE) and/or a variable-gain-amplifier (VGA). Circuitry replicating the receiver AFE is provided with the same gain setting and an offset correction signal as the receiver AFE circuitry. In addition, a common-mode DFE tracking signal is used to correct for common-mode offsets introduced by the DFE tap values. In this manner, as a monitor threshold voltage provided to the input of the replica AFE circuitry is adjusted (e.g., swept), the AFE replica and common-mode DFE tracking compensate for gain variation and common-mode offsets introduced by the AFE circuitry and common-mode offsets due to DFE tap values thereby reducing the inaccuracies in signal eye measurements that would otherwise be introduced without these compensations/tracking.

### BRIEF DESCRIPTION OF THE DRAWINGS

FIG. 1 is a diagram illustrating a decision feedback equalized receiver with monitor circuitry.

FIG. 2 is a diagram illustrating a communication system with decision feedback equalization (DFE).

FIG. 3 is a diagram illustrating a memory system.

FIG. 4 is a flowchart illustrating a method of generating a monitor threshold voltage.

FIG. 5 is a flowchart illustrating a method of operating monitor circuitry.

FIG. 6 is a flowchart illustrating a method of monitoring a signal eye.

FIG. 7 is a block diagram of a processing system.

### DETAILED DESCRIPTION OF THE EMBODIMENTS

Decision feedback equalization (DFE) is used to help reduce inter-symbol interference (ISI) from a data signal received via a band-limited (or otherwise non-ideal) channel. Additional equalization may also be applied to an input signal using analog front-end (AFE) circuitry with, for example, a continuous-time linear equalizer (CTLE) and/or a variable-gain-amplifier (VGA). Signal eye monitoring at a receiver using DFE may be used to help determine DFE coefficients thereby improving ISI correction. In an embodiment, circuitry replicating the receiver AFE is provided with the same gain setting and an offset correction signal as the receiver AFE circuitry. In addition, a common-mode DFE tracking signal is used to correct for common-mode offsets introduced by the DFE tap values. In this manner, as a monitor threshold voltage provided to the input of the replica AFE circuitry is adjusted (e.g., swept), the AFE replica and common-mode DFE tracking compensate for gain variation and common-mode offsets introduced by the AFE circuitry and common-mode offsets due to DFE tap values thereby reducing the inaccuracies in signal eye measurements that would otherwise be introduced without these compensations/tracking.

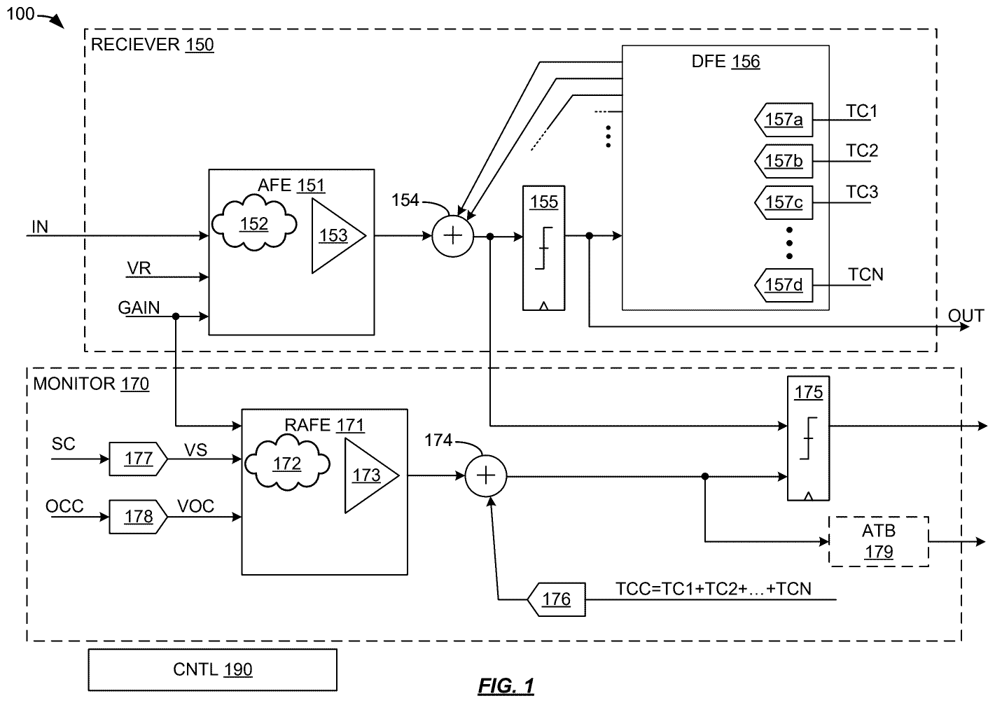

FIG. 1 is a diagram illustrating a decision feedback equalized receiver with monitor circuitry. In FIG. 1, receiver-monitor system 100 comprises receiver circuitry 150, monitor circuitry 170, and control circuitry 190. Receiver circuitry 150 includes AFE circuitry 151, summer 154, sampler 155, and DFE circuitry 156. AFE circuitry 151 may include analog circuitry 152 (e.g., CTLE circuitry) and/or variable gain (or attenuation) circuitry 153 (e.g., VGA circuitry). In an embodiment, variable gain circuitry 153 may be, comprise, or function as, a differential amplifier. DFE circuitry 156 includes tap value digital-to-analog converters (DACs) 157a-157d. Tap value DACs 157a-157d respectively receive tap codes TC1, TC2, TC3, and TCN representing N number of DFE taps implemented by DFE circuity 156.

AFE circuitry 151 receives input signal IN (e.g., from another integrated circuit - not shown in FIG. 1), receiver reference voltage VR, and a gain indicator GAIN. In an embodiment, to produce its output signal that is provided to summer 154, AFE circuitry 151 may equalize the input signal IN using analog circuitry 152. In an embodiment, to produce its output signal that is provided to summer 154, AFE circuitry 151 may amplify or attenuate (e.g., using variable gain circuitry 153) the input signal IN in relation to its difference with reference voltage VR and that difference amplified (or attenuated) by a variable gain amount that is based on gain indicator GAIN. In an embodiment, to produce its output signal that is provided to summer 154, AFE circuitry 151 may both equalize the input signal IN and amplify or attenuate the input signal IN (or other internal signal—e.g., the output of CTLE 153) in relation to its difference with reference voltage VR and that difference amplified (or attenuated) by a variable gain amount that is based on gain indicator GAIN.

The output of AFE circuitry 151 is provided to summer 154. Summer 154 also receives, from DFE circuitry 156, post-cursor ISI removal signals that are, based on corresponding tap codes TC1-TCN, adapted and/or selected to remove post-cursor ISI components from the output of AFE circuitry 151. For example, tap code TC1 may be adapted so that the output of DAC 157a, when combined with (e.g., multiplied by) the first-post cursor sampled value, removes the first post-cursor ISI component from the output of AFE circuitry 151. Similarly, for example, tap code TC2 may be adapted so that the output of DAC 157b, when combined with (e.g., multiplied by) the second-post cursor sampled value, removes the second post-cursor ISI component from the output of AFE circuitry 151, and so on for the additional post-cursor components removed by DFE circuitry 156. The output of summer 154 is provided to signal input of sampler 155 and the signal input of monitor sampler 175. The output of sampler 155 is also the output of receiver circuitry 150.

Monitor circuitry 170 includes replica AFE (RAFE) circuitry 171, summer 174, monitor sampler 175, DFE error tracking DAC 176, sweep voltage DAC 177, RAFE offset correction DAC 178, and (optionally) analog test bus (ATB) 179. RAFE circuitry 171 is a replica of AFE circuitry 151 and/or duplicates and/or mimics some or all of the functions and signal processing performed by AFE circuitry 151. Thus, RAFE circuitry may include analog circuitry 172 (e.g., CTLE circuitry) and/or variable gain (or attenuation) circuitry 173 (e.g., VGA circuitry). In an embodiment, variable gain circuitry 173 may be, comprise, or function as, a differential amplifier.

RAFE circuitry 171 receives a sweep voltage signal VS, an offset correction voltage signal VOC, and the gain indicator GAIN. Sweep voltage signal VS may be produced by sweep voltage DAC 177 based on a digital sweep code SC. Offset correction voltage signal VOC may be produced by RAFE offset correction DAC 178 based on offset correction code OCC. Sweep code SC and/or offset correction code OCC may be produced by, for example, control circuitry 190. In an embodiment, a starting or ending code used when sweeping SC may be used to correct for a common-mode error voltage manifested by AFE 151.

In an embodiment, to produce its output signal that is provided to summer 174, RAFE circuitry 171 may process sweep voltage VS using analog circuitry 172 in the same manner that AFE circuitry 151 processes the input voltage IN using analog circuitry 152. In an embodiment, to produce its output signal that is provided to summer 174, RAFE circuitry 171 may amplify or attenuate (e.g., using variable gain circuitry 173) sweep voltage VS in relation to its difference with offset correction signal VOC and that difference amplified (or attenuated) by a variable gain amount that is based on gain indicator GAIN in the same manner that AFE circuitry 151 amplifies or attenuates the input voltage IN using variable gain circuitry 153. In an embodiment, to produce its output signal that is provided to summer 174, RAFE circuitry 171 may both process the input signal IN and amplify or attenuate the input signal IN (or other internal signal—e.g., the output of CTLE 173) in relation to its difference with offset correction signal and that difference amplified (or attenuated) by a variable gain amount that is based on gain indicator GAIN in the same manner as AFE circuitry 151.

The output of RAFE circuitry 171 is provided to summer 174. Summer 174 also receives, from DFE error tracking DAC 176 a DFE common-mode error correction signal that is based on corresponding tap codes TC1-TCN used by DFE circuitry 156. In an embodiment, DFE common-mode error correction signal output by DFE error tracking DAC 176 is based on a sum (TCC—tap correction code) of the DFE tap codes used by DFE circuitry 156. The output of summer 174 is provided to the threshold voltage input of sampler 155 and (optionally) to ATB 179. The output of monitor sampler 175 is provided to allow measurement of the signal eye of the equalized output of summer 154. For example, sweep code SC may be iteratively swept over a range of values (e.g., lowest limit to highest limit) and the output of monitor sampler 175 sampled for each value and the results of those samples provided to circuitry (e.g., control circuitry 190) to determine the height of the signal eye at the output of summer 154. This eye height may be used to adjust one or more to DFE tap codes TC1-TCN, reference voltage VR, and/or gain indicator GAIN.

It should be understood from the foregoing that system 100 may to adjust the threshold voltage provided to monitor sampler 175 to track variations in the gain/attenuation of AFE circuitry 151, track variations in the common mode offset of AFE circuitry 151, correct for common mode offset introduced by DFE circuitry 156, track the input offset of AFE circuitry 151, and track the input offset of RAFE circuitry 171. It should also be understood that although system 100 is illustrated as receiving a single-ended signal, the signals received and/or monitored (e.g., output of summer 154) may represent differential signals or a collection of signals receiving multi-wire-coded data.

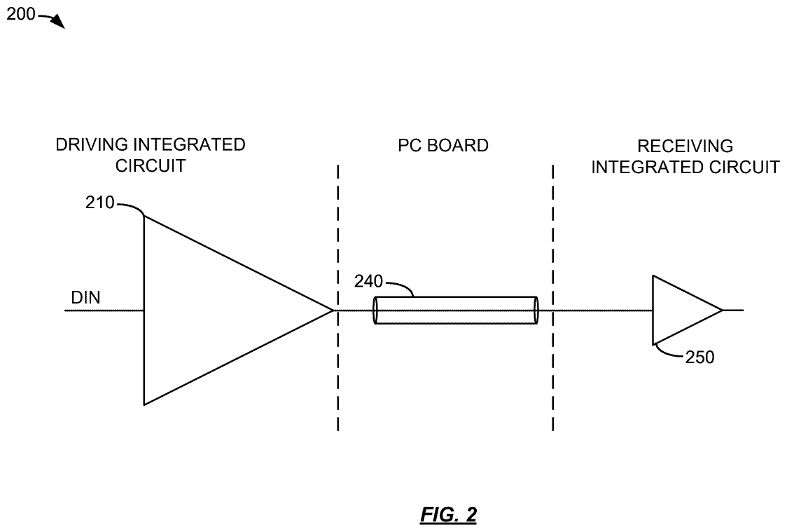

FIG. 2 is a diagram illustrating a communication system with decision feedback equalization (DFE). Communication system 200 comprises a driving integrated circuit, a receiving integrated circuit, and interconnect between them. The driving integrated circuit includes transmitter circuit 210 (a.k.a., a driver). Transmitter circuit 210 may use finite impulse response (FIR) based equalization.

The receiver integrated circuit includes receiver circuitry 250. Receiver circuitry 250 may be, or comprise, receiver circuitry 150 and/or monitor circuitry 170. The interconnect between the driving integrated circuit and the receiving integrated circuit comprises interconnect system 240. Interconnect system 240 would typically comprise a printed circuit (PC) board, connector, cable, flex circuit, other substrate, and/or a combination of these. Interconnect system 240 may be and/or include one or more transmission lines.

Receiver circuitry 250 would typically be part of an integrated circuit that is receiving the signal sent by the driving integrated circuit. It should be understood that termination (not shown in FIG. 2) can be part of the integrated circuit or interconnect system 240. It should also be understood that although system 200 is illustrated as transmitting a single-ended signal, the signals sent by the driving integrated circuit of system 200 may represent one of a pair of differential signals or one of a collection of signals sending multi-wire-coded data.

In FIG. 2, the output of transmitter circuit 210 is connected to a first end of interconnect system 240. The second end of interconnect system 240 is connected to the input of receiver circuitry 250. In an embodiment, transmitter circuit 210 may be configured to drive PAM-4 signaling levels. In another embodiment, transmitter circuit 210 may be configured to drive PAM-2 (non-return to zero—NRZ) signaling levels.

In an embodiment, the receiving integrated circuit (and receiver circuitry 250, in particular) may include receiver circuitry 250 to receive an input signal from interconnect system 240. Receiver circuitry 250 may comprise AFE circuitry and DFE circuitry that collectively generate a summed node signal that is the result of a summing operation, process, or effect. Receiver circuitry 250 may also comprise monitor circuitry to compare the summed node signal and a monitor threshold signal. Receiver circuitry 250 may also comprise AFE replica circuitry to, based on a gain indicator provided to the AFE circuitry and at least one tap value indicator being used by the DFE circuitry, generate the monitor threshold signal.

The AFE replica circuitry may also receive a common-mode error removal signal. A DFE tap error removal signal may be based on a sum of tap value indicators being used by the DFE circuitry. The AFE circuitry may comprise a first differential amplifier circuitry to amplify a first difference between the input signal and a voltage threshold signal, where a first gain of the first differential amplifier circuitry to be based on a gain indicator provided to the AFE circuitry. The replica AFE circuitry may comprise second differential amplifier circuitry to amplify a second difference between a monitor reference signal and a common mode error removal signal, where a second gain of the first differential amplifier circuitry to be based on the gain indicator. The first gain and the second gain may be substantially equal.

In an embodiment, receiver circuitry 250 is to receive an input signal from interconnect system 240 and comprises variable gain AFE circuitry and variable common mode decision feedback equalization DFE circuitry where outputs of the AFE circuitry and the DFE circuitry operate to collectively generate a summed node signal. Monitor sampler reference voltage generator circuitry may, based on a gain indicator provided to the AFE circuitry and a plurality of tap values used by the DFE circuitry, provide a monitor threshold voltage to a monitor sampler.

The monitor sampler reference voltage generator circuitry may be, or comprise, replica AFE circuitry. The monitor sampler reference voltage generator circuitry may comprise a monitor threshold voltage sweep digital-to-analog converter (DAC). The AFE circuitry and the replica AFE circuitry may be provided with a same gain indicator. The monitor sampler reference voltage generator circuitry may comprise a DFE tap code common-mode error tracking DAC to produce a DFE tap code common-mode error tracking signal that may be added to the reference voltage provided to the monitor sampler. The monitor sampler reference voltage generator circuitry may comprise an AFE circuitry input offset tracking DAC to produce an AFE input offset tracking signal that may be provided to the replica AFE circuitry. The AFE circuitry may comprise a first differential amplifier to amplify, based on the same gain indicator, a voltage difference between the input signal and a first reference voltage, the first differential amplifier having a first variable input offset voltage. The replica AFE circuitry may comprise a second differential amplifier having a second variable input offset voltage and the AFE input offset tracking signal replica may be provided to the replica AFE circuitry to set the second variable input offset voltage to be substantially equal to the first variable input offset voltage.

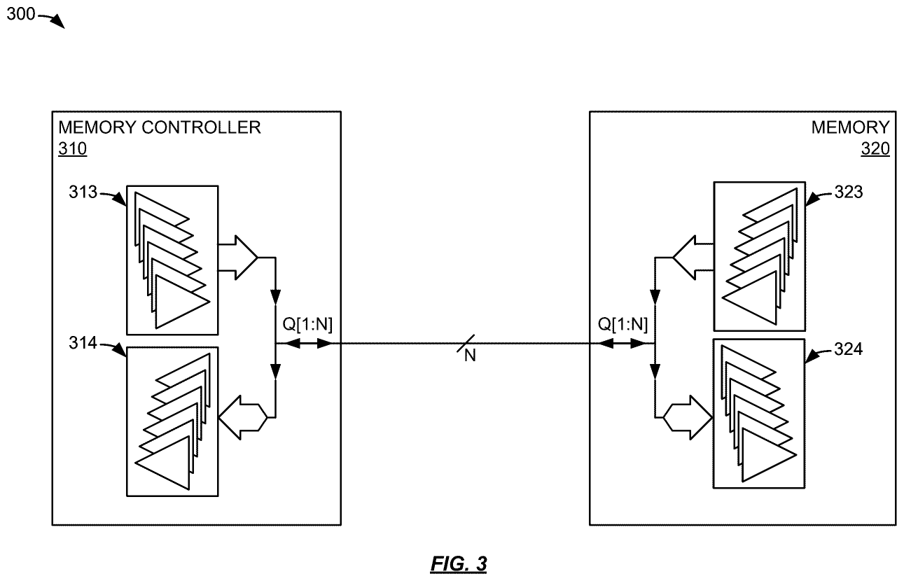

FIG. 3 is a block diagram illustrating a memory system. In FIG. 3, memory system 300 comprises memory controller 310 and memory 320. Memory controller 310 includes drivers 313 and receivers 314. Memory controller 310 also includes N number of signal ports Q[1:N] that may be driven by one or more of drivers 313 and may receive signals to be sampled by one or more of receivers 314. Memory 320 includes drivers 323 and receivers 324.

Memory 320 also includes N number of signal ports Q[1:N] that may be driven by one or more of drivers 323 and may receive signals to be sampled by one or more of receivers 324. Signal ports Q[1:N] of memory controller 310 are operatively coupled to ports Q[1:N] of memory 320, respectively. Receivers 324 of memory 320 may receive one or more of the Q[1:N] signals from memory controller 310. Receivers 314 of memory controller 310 may receive one or more of the Q[1:N] signals from memory 320.

One or more of drivers 313 when configured and coupled with a corresponding one or more receivers 324 may form a PAM-2 signaling system or a PAM-4 signaling system. Thus, one or more of drivers 313 of memory controller 310 may correspond to transmitter circuit 210, discussed previously, or correspond to a transmitter circuit discussed herein subsequently. One or more of receivers 314 of memory controller 310 may correspond to receiver circuitry 250, discussed previously, or correspond to a receiver circuit discussed herein subsequently. The one or more of receivers 314 of memory controller 310 may use a DFE architecture that uses the current input voltage (symbol) received via from memory 320 as an input to help determine a DFE feedback signal.

One or more of drivers 323 when configured and coupled with a corresponding one or more receivers 314 may form a PAM-2 signaling system or a PAM-4 signaling system. Thus, one or more of drivers 323 of memory 320 may correspond to transmitter circuit 210, discussed previously, or correspond to a transmitter circuit discussed herein subsequently. One or more of receivers 324 of memory 320 may correspond to receiver circuitry 250, discussed previously, or correspond to a receiver circuit discussed herein subsequently. The one or more of receivers 324 of memory 320 may use a DFE architecture that uses the current input voltage (symbol) received from memory controller 310 as an input to help determine a DFE feedback signal.

Memory controller 310 and memory 320 are integrated circuit type devices, such as one commonly referred to as a “chip”. A memory controller, such as memory controller 310, manages the flow of data going to and from memory devices, such as memory 320. For example, a memory controller may be a northbridge chip, an application specific integrated circuit (ASIC) device, a graphics processor unit (GPU), a system-on-chip (SoC) or an integrated circuit device that includes many circuit blocks such as ones selected from graphics cores, processor cores, and MPEG encoder/decoders, etc. Memory 320 can include a dynamic random access memory (DRAM) core or other type of memory cores, for example, static random access memory (SRAM) cores, or non-volatile memory cores such as flash. In addition, although the embodiments presented herein describe memory controller and components, the instant apparatus and methods may also apply to chip interfaces that effectuate signaling between separate integrated circuit devices.

It should be understood that signal ports Q[1:N] of both memory controller 310 and memory 320 may correspond to any input or output pins (or balls) of memory controller 310 or memory 320 that transmit information between memory controller 310 and memory 320. For example, signal ports Q[1:N] can correspond to bidirectional data pins (or pad means) used to communicate read and write data between memory controller 310 and memory 320. The data pins may also be referred to as “DQ” pins. Thus, for a memory 320 that reads and writes data up to 16 bits at a time, signal ports Q[1:N] can be seen as corresponding to pins DQ[0:15]. In another example, signal ports Q[1:N] can correspond to one or more unidirectional command/address (C/A) bus. Signal ports Q[1:N] can correspond to one or more unidirectional control pins. Thus, signal ports Q[1:N] on memory controller 310 and memory 320 may correspond to pins such as CS (chip select), a command interface that includes timing control strobes such as RAS and CAS, address pins A[0:P] (i.e., address pins carrying address bits), DQ[0:X] (i.e., data pins carrying data bits), etc., and other pins in past, present, or future devices.

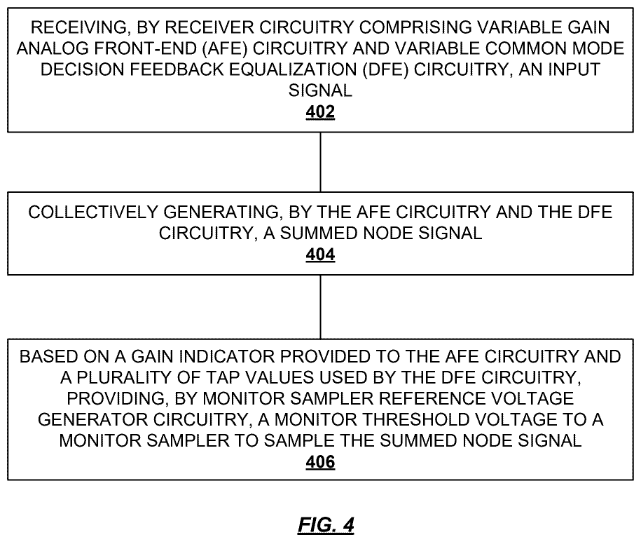

FIG. 4 is a flowchart illustrating a method of generating a monitor threshold voltage. The steps illustrated in FIG. 4 may be performed by one or more elements of system 100, system 200, and/or system 300. By receiver circuitry comprising variable gain analog front-end (AFE) circuitry and variable common mode decision feedback equalization (DFE) circuitry, an input signal is received (402). For example, receiver circuitry 150 that includes AFE circuitry 151 and DFE circuitry 156, may receive an input signal IN.

Collectively generate, by the AFE circuitry and the DFE circuitry, a summed node signal (404). For example, the output of AFE circuitry 151 in response to the input signal IN, and the outputs of DFE circuitry 156 in response to post-cursor samples by sampler 155, may be summed by summer 154 to generate an equalized signal that is provided to the data input of sampler 155. Based on a gain indicator provided the AFE circuitry, a plurality of tap values used by the DFE circuitry, and by monitor sampler reference voltage generator circuitry, a monitor threshold voltage is provided to a monitor sampler to sample the summed node signal (406). For example, based on the gain indicator GAIN provided to AFE circuitry 151 and replica AFE circuitry 171, and a the tap values TC1-TCN used by DFE circuitry 156 and DFE error tracking DAC 176, summer 174 may produce, from the output of replica AFE circuitry 171 and the output of DFE error tracking DAC 176, a monitor sampler reference voltage that is provided to monitor sampler 175 to sample the output of summer 154.

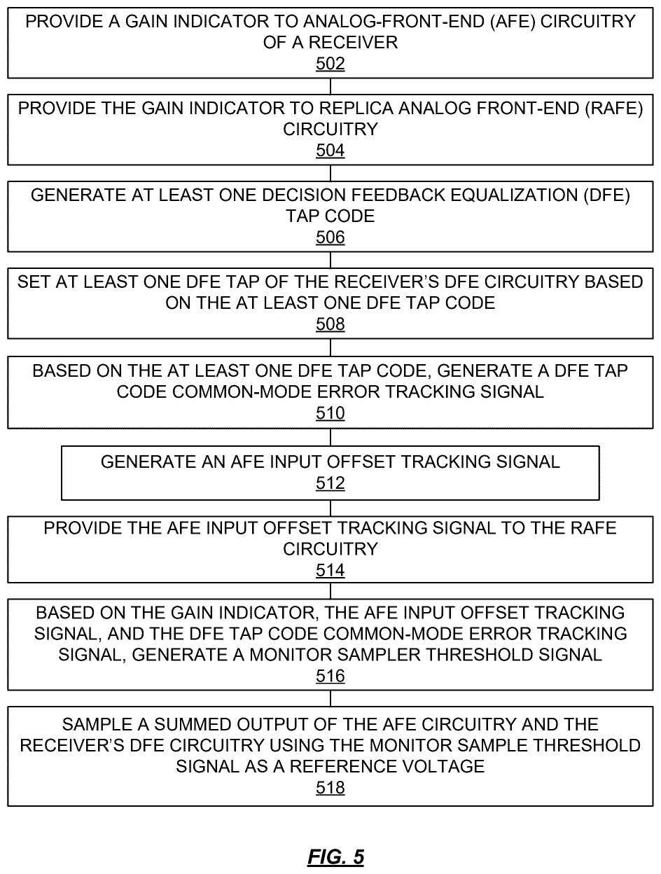

FIG. 5 is a flowchart illustrating a method of operating monitor circuitry. The steps illustrated in FIG. 5 may be performed by one or more elements of system 100, system 200, and/or system 300. A gain indicator is provided to analog front-end (AFE) circuitry of a receiver (502). For example, gain indicator GAIN (which may be a digital value and/or an analog current or voltage signal), may be provided to AFE circuitry 151 (e.g., to set the gain of variable gain circuitry 153). The gain indicator is provided to replica analog front-end circuitry (RAFE) (504). For example, the same gain indicator GAIN that was provided to AFE circuitry 151 may be provided to RAFE circuitry 171 (e.g., to set the gain of variable gain circuitry 173).

At least one decision feedback equalization (DFE) tap code is generated (506). For example, control circuitry 190 may generate one or more DFE tap code TC1-TCN. At least one DFE tap of the receiver's DFE circuitry is set based on the at least one DFE tap code (508). For example, TC1 may be used to set the output voltage of tap value DAC 157a which is a basis for a weight of a DFE tap of DFE circuitry 156. Based on the at least one DFE tap code, a DFE tap code common-mode error tracking signal is generated (510). For example, based on a sum (TCC=TC1+TC2+. . . TCN) of tap code values TC1-TCN used by DFE circuitry 156 that is provided to DFE error tracking DAC 176, DFE tracking DAC 176 may generate a DFE tap code common-mode error tracking signal that is provided to summer 174 to be summed with the output of RAFE circuitry 171.

An AFE input offset tracking signal is generated (512). For example, control circuitry 190 (e.g., a finite-state machine) or off-chip test circuitry (via ATB 179 and/or the outputs of monitor sampler 175) may generate an offset correction code OCC that is provided to RAFE offset correction DAC 178 to produce offset correction voltage signal VOC. The AFE input offset tracking signal is provided to the RAFE circuitry (514). For example, offset correction voltage signal VOC may provided by RAFE offset correction DAC 178 to RAFE circuitry 171.

Based on the gain indicator, the AFE input offset tracking signal, and the DFE tap code common-mode error tracking signal, a monitor sampler threshold signal is generated (516). For example, RAFE circuitry 171 based on the gain indicator GAIN, based on the input offset tracking signal VOC, and further based on the sweep voltage signal VS, may output a signal that is summed, by summer 174, with the DFE tap code common-mode error tracking signal output by DFE tracking DAC 176. The result of the summing by summer 174 may be provided as the threshold voltage for monitor samplers 175. A summed output of the AFE circuitry and the receiver's DFE circuitry is sampled using the monitor sample threshold signal as a reference voltage (518). For example, the output of summer 154, which is the sum of the output of AFE circuitry 151 and the tap outputs of DFE circuitry 156, may be sampled by monitor sampler 175 using the output of summer 174 as a reference voltage. The samples sampled by monitor sampler 175 over a range of monitor threshold voltages (e.g., resulting from a sweep of sweep code SC through a range of values) may be used in signal eye measurements (e.g., height, shape, etc.)

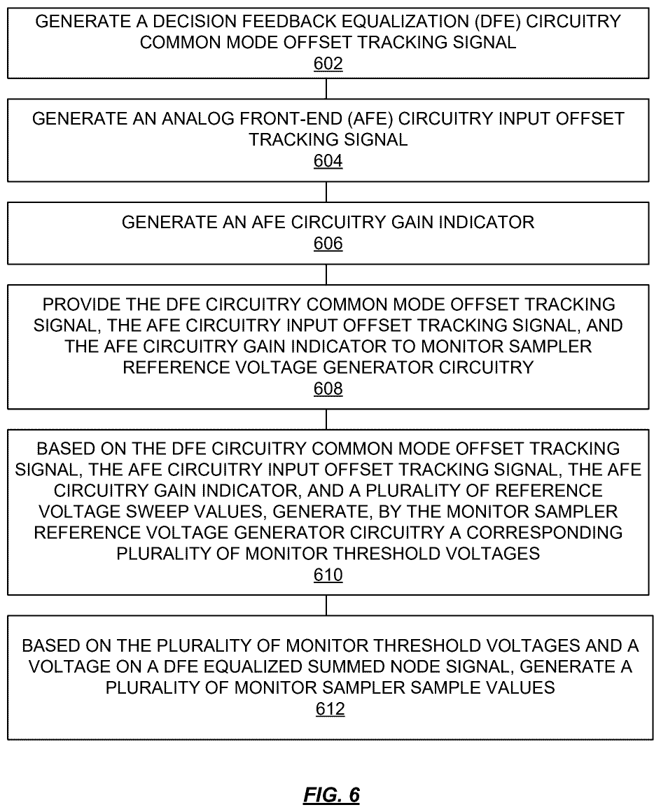

FIG. 6 is a flowchart illustrating a method of monitoring a signal eye. The steps illustrated in FIG. 6 may be performed by one or more elements of system 100, system 200, and/or system 300. A decision feedback equalization (DFE) circuitry common mode offset tracking signal is generated (602). For example, a DFE tap code common-mode error tracking signal output by DFE tracking DAC 176 based on the sum of the tap code values TC1-TCN used by DFE circuitry 156 may be generated by DFE tracking DAC 176.

An analog front-end (AFE) input offset tracking signal is generated (604). For example, control circuitry 190 (e.g., a finite-state machine) or off-chip test circuitry (via ATB 179 and/or the outputs of monitor sampler 175) may generate an offset correction code OCC that is provided to RAFE offset correction DAC 178 to produce offset correction voltage signal VOC. An AFE circuitry gain indicator is generated (606). For example, control circuitry 190 may generate gain indicator GAIN (which may be a digital value and/or an analog current or voltage signal).

The DFE circuitry common-mode error tracking signal, the AFE circuitry input offset tracking signal, and the AFE circuitry gain indicator are provided to monitor sampler reference voltage generator circuitry (608). For example, the output of by DFE tracking DAC 176 and the output of RAFE circuitry 171, which is provided with offset correction voltage signal VOC and gain indicator GAIN, may be provided to summer 174. Based on the DFE common mode offset tracking signal, the AFE circuitry input offset tracking signal, the AFE circuitry gain indicator, and a plurality of reference voltage sweep values, and by the monitor sample reference voltage generator circuitry, a corresponding plurality of monitor reference voltages are generated (610). For example, RAFE circuitry 171 may receive, in addition to VOC and GAIN, a plurality of sweep voltages from sweep voltage DAC 177 that were based on a corresponding plurality of sweep code values (e.g., a sweep over a range of code values) and based on these sweep voltage values RAFE circuitry 171 may produce a corresponding plurality of output voltages that are summed by summer 174 with the output of DFE tracking DAC 176 to produce a corresponding plurality of monitor sampler threshold voltages that are used by monitor sampler 175.

Based on the plurality of monitor threshold voltage and a voltage on a DFE equalized summed node signal, a plurality of monitor sampler sample values are generated (612). For example, for each of the monitor sampler threshold voltages that are used by monitor sampler 175, the output of summer 154 may be sampled one or more times to generate a plurality of monitor sampler sample value (e.g., over a range that may be used to make eye signal measurements).

The methods, systems and devices described above may be implemented in computer systems, or stored by computer systems. The methods described above may also be stored on a non-transitory computer readable medium. Devices, circuits, and systems described herein may be implemented using computer-aided design tools available in the art, and embodied by computer-readable files containing software descriptions of such circuits. This includes, but is not limited to one or more elements of system 100, system 200, and/or system 300, and their components. These software descriptions may be: behavioral, register transfer, logic component, transistor, and layout geometry-level descriptions. Moreover, the software descriptions may be stored on storage media or communicated by carrier waves.

Data formats in which such descriptions may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email. Note that physical files may be implemented on machine-readable media such as: 4 mm magnetic tape, 8 mm magnetic tape, 3½ inch floppy media, CDs, DVDs, and so on.

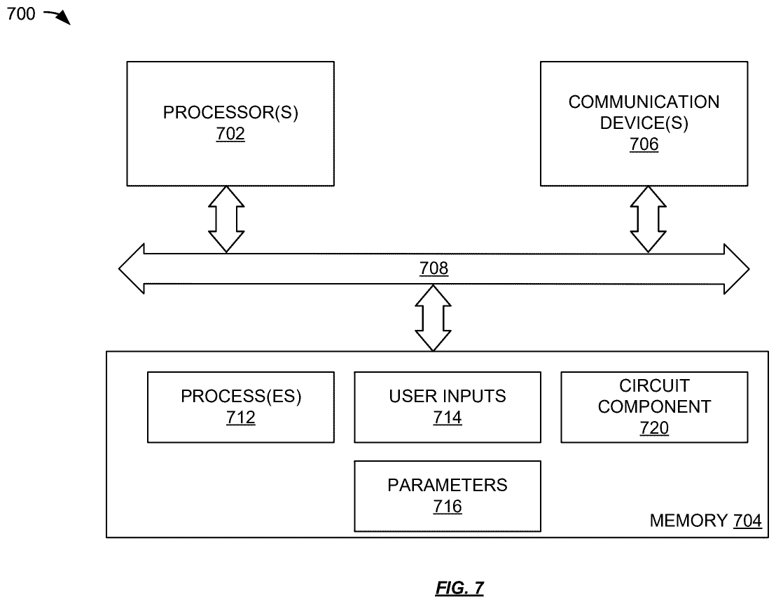

FIG. 7 is a block diagram illustrating one embodiment of a processing system 700 for including, processing, or generating, a representation of a circuit component 720. Processing system 700 includes one or more processors 702, a memory 704, and one or more communications devices 706. Processors 702, memory 704, and communications devices 706 communicate using any suitable type, number, and/or configuration of wired and/or wireless connections 708.

Processors 702 execute instructions of one or more processes 712 stored in a memory 704 to process and/or generate circuit component 720 responsive to user inputs 714 and parameters 716. Processes 712 may be any suitable electronic design automation (EDA) tool or portion thereof used to design, simulate, analyze, and/or verify electronic circuitry and/or generate photomasks for electronic circuitry. Representation 720 includes data that describes all or portions system 100, system 200, and/or system 300, and their components, as shown in the Figures.

Representation 720 may include one or more of behavioral, register transfer, logic component, transistor, and layout geometry-level descriptions. Moreover, representation 720 may be stored on storage media or communicated by carrier waves.

Data formats in which representation 720 may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email.

User inputs 714 may comprise input parameters from a keyboard, mouse, voice recognition interface, microphone and speakers, graphical display, touch screen, or other type of user interface device. This user interface may be distributed among multiple interface devices. Parameters 716 may include specifications and/or characteristics that are input to help define representation 720. For example, parameters 716 may include information that defines device types (e.g., NFET, PFET, etc.), topology (e.g., block diagrams, circuit descriptions, schematics, etc.), and/or device descriptions (e.g., device properties, device dimensions, power supply voltages, simulation temperatures, simulation models, etc.).

Memory 704 includes any suitable type, number, and/or configuration of non-transitory computer-readable storage media that stores processes 712, user inputs 714, parameters 716, and circuit component 720.

Communications devices 706 include any suitable type, number, and/or configuration of wired and/or wireless devices that transmit information from processing system 700 to another processing or storage system (not shown) and/or receive information from another processing or storage system (not shown). For example, communications devices 706 may transmit circuit component 720 to another system. Communications devices 706 may receive processes 712, user inputs 714, parameters 716, and/or circuit component 720 and cause processes 712, user inputs 714, parameters 716, and/or circuit component 720 to be stored in memory 704.

Implementations discussed herein include, but are not limited to, the following examples:
Example 1: An integrated circuit, comprising: receiver circuitry to receive an input signal and comprising analog front-end (AFE) circuitry and decision feedback equalization (DFE) circuitry, the AFE circuitry and the DFE circuitry to collectively generate a summed node signal; monitor circuitry to compare the summed node signal and a monitor threshold signal; and AFE replica circuitry to, based on a gain indicator provided to the AFE circuitry and at least one tap value indicator being used by the DFE circuitry, generate the monitor threshold signal.
Example 2: The integrated circuit of claim 1, wherein the AFE replica circuitry is to also receive a common-mode error removal signal.
Example 3: The integrated circuit of claim 2, wherein a DFE tap error removal signal is based on a sum of tap value indicators being used by the DFE circuitry.
Example 4: The integrated circuit of claim 3, wherein the AFE circuitry comprises a first differential amplifier circuitry to amplify a first difference between the input signal and a voltage threshold signal, a first gain of the first differential amplifier circuitry to be based on a gain indicator provided to the AFE circuitry.
Example 5: The integrated circuit of claim 4, wherein the replica AFE circuitry comprises a second differential amplifier circuitry to amplify a second difference between a monitor reference signal and a common mode error removal signal, a second gain of the first differential amplifier circuitry to be based on the gain indicator.
Example 6: The integrated circuit of claim 5, wherein the first gain and the second gain are substantially equal.
Example 7: An integrated circuit, comprising: receiver circuitry to receive an input signal and comprising variable gain analog front-end (AFE) circuitry and variable common mode decision feedback equalization (DFE) circuitry, the AFE circuitry and the DFE circuitry to collectively generate a summed node signal; and monitor sampler reference voltage generator circuitry to, based on a gain indicator provided to the AFE circuitry and a plurality of tap values used by the DFE circuitry, provide a monitor threshold voltage to a monitor sampler.
Example 8: The integrated circuit of claim 7, wherein the monitor sampler reference voltage generator circuitry comprises replica AFE circuitry.
Example 9: The integrated circuit of claim 8, wherein the monitor sampler reference voltage generator circuitry comprises a monitor threshold voltage sweep digital-to-analog converter (DAC).
Example 10: The integrated circuit of claim 9, wherein the AFE circuitry and the replica AFE circuitry are provided with a same gain indicator.
Example 11: The integrated circuit of claim 10, wherein the monitor sampler reference voltage generator circuitry comprises a DFE tap code common-mode error tracking DAC to produce a DFE tap code common-mode error tracking signal that is to be added to the reference voltage provided to the monitor sampler.
Example 12: The integrated circuit of claim 11, wherein the monitor sampler reference voltage generator circuitry comprises an AFE circuitry input offset tracking DAC to produce an AFE input offset tracking signal that is to be provided to the replica AFE circuitry.
Example 13: The integrated circuit of claim 12, wherein the AFE circuitry comprises a first differential amplifier to amplify, based on the same gain indicator, a voltage difference between the input signal and a first reference voltage, the first differential amplifier having a first variable input offset voltage.
Example 14: The integrated circuit of claim 13, wherein the replica AFE circuitry comprises a second differential amplifier having a second variable input offset voltage and the AFE input offset tracking signal replica is provided to the replica AFE circuitry to set the second variable input offset voltage to be substantially equal to the first variable input offset voltage.
Example 15: A method of operating an integrated circuit, comprising: receiving, by receiver circuitry comprising variable gain analog front-end (AFE) circuitry and variable common mode decision feedback equalization (DFE) circuitry, an input signal; collectively generating, by the AFE circuitry and the DFE circuitry, a summed node signal; and based on a gain indicator provided to the AFE circuitry and a plurality of tap values used by the DFE circuitry, providing, by monitor sampler reference voltage generator circuitry, a monitor threshold voltage to a monitor sampler to sample the summed node signal.
Example 16: The method of claim 15, wherein the monitor sampler reference voltage generator circuitry comprises replica AFE circuitry.
Example 17: The method of claim 16, wherein the monitor sampler reference voltage generator circuitry comprises a monitor threshold voltage sweep digital-to-analog converter (DAC).
Example 18: The method of claim 17, further comprising: providing the AFE circuitry and the replica AFE circuitry with a same gain indicator.
Example 19: The method claim 18, further comprising: generating, using a DFE tap code common-mode error tracking DAC, a DFE tap code common-mode error tracking signal; and adding the DFE tap code common-mode error tracking signal to the reference voltage provided to the monitor sampler.
Example 20: The method of claim 19, further comprising: generating, using an AFE circuitry input offset tracking DAC, an AFE input offset tracking signal; and providing the AFE input offset tracking signal to the replica AFE circuitry.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. An integrated circuit, comprising:
receiver circuitry to receive an input signal and comprising analog front-end (AFE) circuitry and decision feedback equalization (DFE) circuitry, the AFE circuitry and the DFE circuitry to collectively generate a summed node signal;
monitor circuitry to compare the summed node signal and a monitor threshold signal; and
AFE replica circuitry to, based on a gain indicator provided to the AFE circuitry and at least one tap value indicator being used by the DFE circuitry, generate the monitor threshold signal.

2. The integrated circuit of claim 1, wherein the AFE replica circuitry is to also receive a common-mode error removal signal.

3. The integrated circuit of claim 2, wherein a DFE tap error removal signal is based on a sum of tap value indicators being used by the DFE circuitry.

4. The integrated circuit of claim 3, wherein the AFE circuitry comprises a first differential amplifier circuitry to amplify a first difference between the input signal and a voltage threshold signal, a first gain of the first differential amplifier circuitry to be based on a gain indicator provided to the AFE circuitry.

5. The integrated circuit of claim 4, wherein the replica AFE circuitry comprises a second differential amplifier circuitry to amplify a second difference between a monitor reference signal and a common mode error removal signal, a second gain of the first differential amplifier circuitry to be based on the gain indicator.

6. The integrated circuit of claim 5, wherein the first gain and the second gain are substantially equal.

7. An integrated circuit, comprising:
receiver circuitry to receive an input signal and comprising variable gain analog front-end (AFE) circuitry and variable common mode decision feedback equalization (DFE) circuitry, the AFE circuitry and the DFE circuitry to collectively generate a summed node signal; and
monitor sampler reference voltage generator circuitry to, based on a gain indicator provided to the AFE circuitry and a plurality of tap values used by the DFE circuitry, provide a monitor threshold voltage to a monitor sampler.

8. The integrated circuit of claim 7, wherein the monitor sampler reference voltage generator circuitry comprises replica AFE circuitry.

9. The integrated circuit of claim 8, wherein the monitor sampler reference voltage generator circuitry comprises a monitor threshold voltage sweep digital-to-analog converter (DAC).

10. The integrated circuit of claim 9, wherein the AFE circuitry and the replica AFE circuitry are provided with a same gain indicator.

11. The integrated circuit of claim 10, wherein the monitor sampler reference voltage generator circuitry comprises a DFE tap code common-mode error tracking DAC to produce a DFE tap code common-mode error tracking signal that is to be added to the reference voltage provided to the monitor sampler.

12. The integrated circuit of claim 11, wherein the monitor sampler reference voltage generator circuitry comprises an AFE circuitry input offset tracking DAC to produce an AFE input offset tracking signal that is to be provided to the replica AFE circuitry.

13. The integrated circuit of claim 12, wherein the AFE circuitry comprises a first differential amplifier to amplify, based on the same gain indicator, a voltage difference between the input signal and a first reference voltage, the first differential amplifier having a first variable input offset voltage.

14. The integrated circuit of claim 13, wherein the replica AFE circuitry comprises a second differential amplifier having a second variable input offset voltage and the AFE input offset tracking signal replica is provided to the replica AFE circuitry to set the second variable input offset voltage to be substantially equal to the first variable input offset voltage.

15. A method of operating an integrated circuit, comprising:
receiving, by receiver circuitry comprising variable gain analog front-end (AFE) circuitry and variable common mode decision feedback equalization (DFE) circuitry, an input signal;
collectively generating, by the AFE circuitry and the DFE circuitry, a summed node signal; and
based on a gain indicator provided to the AFE circuitry and a plurality of tap values used by the DFE circuitry, providing, by monitor sampler reference voltage generator circuitry, a monitor threshold voltage to a monitor sampler to sample the summed node signal.

16. The method of claim 15, wherein the monitor sampler reference voltage generator circuitry comprises replica AFE circuitry.

17. The method of claim 16, wherein the monitor sampler reference voltage generator circuitry comprises a monitor threshold voltage sweep digital-to-analog converter (DAC).

18. The method of claim 17, further comprising:
providing the AFE circuitry and the replica AFE circuitry with a same gain indicator.

19. The method claim 18, further comprising:
generating, using a DFE tap code common-mode error tracking DAC, a DFE tap code common-mode error tracking signal; and
adding the DFE tap code common-mode error tracking signal to the reference voltage provided to the monitor sampler.

20. The method of claim 19, further comprising:
generating, using an AFE circuitry input offset tracking DAC, an AFE input offset tracking signal; and
providing the AFE input offset tracking signal to the replica AFE circuitry.
